(19) United States
(12) Patent Application Publication
(10) Pub. No.: US 2013/0024429 A1
(43) Pub. Date: Jan. 24, 2013

(54) Multi-Jurisdiction Retention Scheduling For Record Management

(71) Applicant: Urs Raas, Newbury (GB)

(72) Inventor: Urs Raas, Newbury (GB)

(73) Assignee: Hewlett-Packard Development Company, L.P., Fort Collins, CO (US)

(21) Appl. No.: 13/579,390

(22) PCT Filed: Apr. 29, 2010
(86) PCT No.: PCT/US10/32891

§ 371 Date: Oct. 4, 2012

(51) Int. Cl. G06F 17/30

(52) U.S. Cl. 707/689; 707/E17.005

(57) ABSTRACT

A retention schedule is assigned to a record based on classification information associated with the record, wherein the retention schedule is linked to a plurality of jurisdiction triggers. Expiration dates for those jurisdiction triggers that correspond to jurisdiction information associated with the record are determined. A record expiration date for the record is selected from the determined expiration dates.

### BACKGROUND

Managing records in a rapidly changing technological environment often can be challenging due to multiple and differing management polices imposed by various entities. Such policies often may include retention requirements relating to archiving and destroying particular classes of records, such as corporate financial records, personnel files, contracts, etc. Retention requirements for an organization's records may be imposed by various different jurisdictional entities, including internal bodies within the organization's hierarchical structure and external entities outside the organization, such as various legal or regulatory entities.

### BRIEF DESCRIPTION OF THE DRAWINGS

Some embodiments are described with respect to the following figures:

FIG. 1 is a block diagram of an exemplary record management system, in accordance with an embodiment of the invention.

FIG. 2 is a flow diagram of an exemplary multi-jurisdiction retention scheduling technique that may be implemented in the system of FIG. 1, in accordance with an embodiment of the invention.

### DETAILED DESCRIPTION

Corporate organizations often maintain record management systems for managing the storage and retention of records. To enable sharing of records throughout the organization, such management systems typically store records in a centralized record repository, which may include various servers or relational database systems that may be accessed from any location in the organization via a network. However, due to the sensitive nature of some records, access to the records must be controlled. In addition, to comply with internal and external retention requirements imposed by various jurisdictional entities, retention and destruction of records generally should be controlled in a defined manner.

Ensuring consistent compliance with these requirements in a large organization can be particularly challenging, since not only may there be different requirements for each class or type of records, but each jurisdictional entity may impose different retention requirements for a particular class of records and these requirements could potentially change at any time. These challenges are compounded when a particular record retained by an organization is shared by multiple jurisdictions, each of which may have a different retention policy. A jurisdiction may be any entity that imposes a retention policy on records, including a country, a state, a municipality, an organization (e.g., group, division, department, etc.) within the hierarchical structure of a corporation, etc., including any combinations of the foregoing.

To address these challenges, exemplary embodiments of the invention are directed toward a record management system 100 that generates a storage specification 112 that is associated with each record 110 maintained by the organization, such as in a record repository 114. The storage specification 112 may dictate various record management parameters, including, for example, access restrictions, handling limitations, encryption requirements, and retention and destruction schedules for the associated record 110. In exemplary embodiments, a storage specification 112 may be generated by a storage specification generator 116 at or near the time the record 110 is created or at least before the record 110 is placed in the record repository 114. The storage specification 112 may then be stored or associated with or linked to the record 110 stored in the record repository 114.

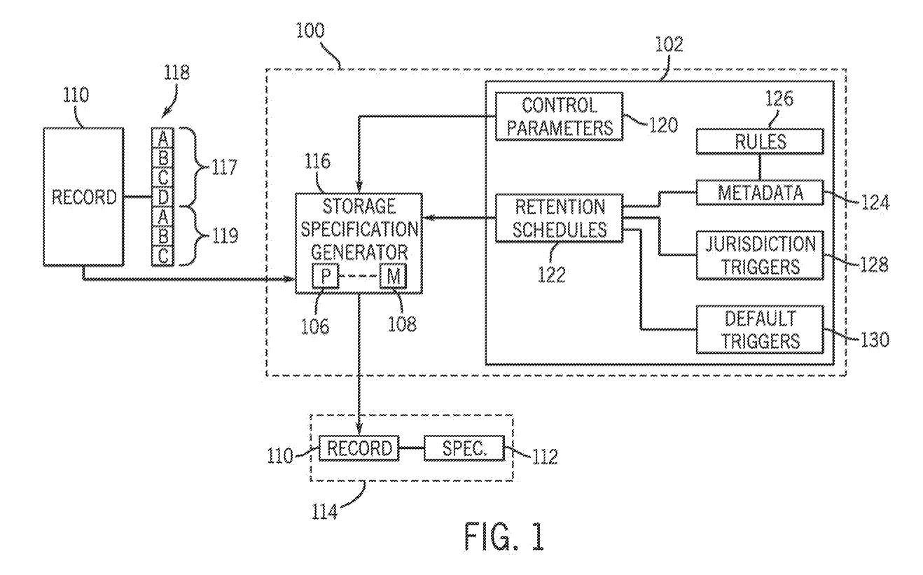

FIG. 1 illustrates an exemplary record management system 100 for generating a storage specification 112 for a record 110 in accordance with an embodiment of the invention, where the storage specification 112 includes (among other parameters) a record expiration date or dates determined in accordance with a record retention schedule that is applicable across multiple jurisdictions. The portion of the system 100 illustrated in FIG. 1 may be part of a larger computing system for an organization that is maintained on one or several servers, databases, or other storage devices (e.g., storage device 102 in FIG. 1) on which various software applications, instructions of code and data also are maintained to perform various functions for the organization. The system 100 may further include one or several processor-based devices (e.g., microcontrollers, microprocessors, etc.), such as the processor 106, that cooperates with a memory 108 (that may include both volatile and non-volatile memory elements) to execute the various applications and instructions of code to carry out the processing functions.

Referring still to FIG. 1, upon creation of the record 110, various identifying information 118 may also be created for the record 110. The identifying information 118 may include classification information 117 and jurisdiction information 119. In the embodiment shown, the classification information 117 includes various codes or labels, such as a unique identifier 117A and indicators 117B-D that correspond to characteristics related to the record's origination, ownership and content. The jurisdiction information 119 may include codes or labels 119A-C, each of which correspond to a jurisdictional entity (e.g., country, state, municipality, group, division, department, etc.). The particular identifying information 118 assigned to the record 110 may be selected by the organization based on the manner in which the organization desires or is required to manage its records. For instance, the classification information 117 may include a label 117B that indicates the business context in which the record 110 was created (e.g., legal department, research department, human resources department, accounting department, etc.), a label 117C that indicates the type of information contained in the record 110 (e.g., technical report, financial information, personnel record, business proposal, contract, etc.), a label 117C that indicates the origin of the record 110 (e.g., location, user, group, etc.), a label 117D that provides an indication of whether the record is confidential or public, and so forth.

The foregoing types of classifying information 117 are provided as examples only. It should be understood that fewer, more or different types of classifying information 117 may be assigned to each record 110 depending on the particular record management system 100 and policies implemented by or imposed on the organization.

In some embodiments, the identifying information 118 may be assigned manually by a user (e.g., the creator of the document, a records manager, etc.), automatically by the record management system 100 based on, for instance, the identity of the person or location of the person who created the record 110, or a combination of manual and automatic assignment. The identifying information 118 may be stored separately from the record 110 with a cross-reference thereto or may be included as part of the indexing of the record 110. In any case, the identifying information 118 may be used to classify the record 110 and eventually to generate the record storage specification 112 that dictates the manner in which the record 110 should be managed after it is stored in the organization's record repository 114.

As an example, in some embodiments, various control parameters 120 and a retention schedule 122 may be assigned to a record 110 based on the identifying information 118. The assigned control parameters 120 and record expiration dates for the retention schedule 122 may then be included in the storage specification 112 that is generated for each record 110. Based on the classifying information 117, for instance, the storage specification generator 116 may assign particular control parameters 120, such as an access restriction that applies to the record 110 (e.g., public access permitted; access restricted to users in a particular department, etc.), the number of copies that may be made of each record 110, various encryption schemes to be used with the record 110, etc. The specification generator 116 may also select a retention schedule 122 based on the classifying information 117, where the retention schedule 122 is used to determine record expiration dates upon or after which the corresponding record 110 may be transferred to archival storage and/or destroyed.

In general, retention schedules 122 control the manner in which a record 110 should be treated after passage of a certain period of time. For instance, retention policies may require that aged records be moved into a storage archive and/or that certain records be destroyed on or after a particular expiration date. In some embodiments, the retention policy may require permanent retention of the record, in which case the record may be marked with a “do not destroy” flag or other indication. For classes or types of records that may be archived and/or destroyed, the expiration dates generally are calculated from a base triggering event, such as a date of creation or a the date of a future event (e.g., termination date of an employee, fiscal year end, etc.) using a defined retention time period. Both the retention time periods and the base triggering events may be established by external or internal jurisdictional entities. These retention periods and trigger events typically differ based on the type or class of record. For instance, the retention policy for financial records may specify that financial records may be archived after a period of seven years from the end of the fiscal year in which the record was created and then destroyed ten years after the date of creation. Personnel records created by a corporation's human resources department may be subject to a different retention policy than financial records, including a different expiration period measured from a different base event date. For instance, the retention policy for personnel records may require that the records be kept for a period of five years after the date on which the employee's relationship with the corporation is terminated.

Record management system 100 may facilitate implementation of retention policies since a particular retention schedule 122 may be automatically linked to a record 110 based on the identifying information 118 associated with the record 110. When the record 110 then expires as determined by the retention schedule, the document management system 100 may automatically transfer the record 110 to archival storage, destroy the record, or provide an indication to a user or records manager of the system 100 of the expiration of the record so that appropriate action can be taken. In the event that retention policies for a particular jurisdiction change over time or new jurisdictions are added to the system 100, the automated features of the management system 100 may facilitate updating of the record expiration dates that correspond to the various records 110.

Despite the automated capabilities of document management system 100, difficulties may arise in organizations that share records across multiple jurisdictions since the various jurisdictions may have different retention requirements for the same class of records. For instance, the retention requirements for financial records in the United States may be different than the retention requirements for financial records in Germany. Thus, for global organizations, assignment of a retention schedule 122 to a record 110 may not simply be based on the type or class of record 110, but also should take into consideration the jurisdiction in which the record 110 is used. Further complications may arise if a particular record 110 is shared by multiple jurisdictions (e.g., a multi-country supply contract, for instance). In such situations, in order to ensure compliance with the different retention policies, multiple copies of the record, each with a dedicated retention schedule, may need to be maintained for each jurisdiction if the record management system 100 is not equipped to implement multi-jurisdiction scheduling.

Accordingly, to address these complications, the retention schedules 122 in the record management system 100 are multi-jurisdiction retention schedules that are assigned to records 110 based on the classifying information 117. Record expiration dates for the corresponding record 110 may then be determined based on the jurisdictional information 119 associated with the record 110.

In an exemplary embodiment, each retention schedule 122 includes a set of metadata 124 or descriptive information that describes the type or class of records to which the schedule 122 should be assigned. A schedule 122 may be assigned to a record 110 by comparing the schedule's metadata 124 to the classification information 117 attached to the record 110. In some embodiments, business rules 126 may be linked to the metadata, such as a rule that requires the specification generator 116 to examine the unique identifier label 117A associated with the record 110, a rule that requires the specification generator 116 to determine whether a “do not destroy” flag is associated with the record 110 before calculating expiration dates, etc.

Each retention schedule 122 also may be linked to a jurisdiction trigger 128. In one embodiment, a jurisdiction trigger 128 may be defined by a combination of information, such as a time duration (e.g., years, months, days, seconds, milliseconds, etc.), a base event date to which the time duration is applied to calculate an expiration date, and a jurisdictional code or identifier to which the trigger 128 should apply. For each applicable jurisdiction, the jurisdiction trigger 128 linked to an assigned retention schedule 122 may be used to calculate the expiration date on which the record 110 should be destroyed and/or transferred to a storage archive.

In some embodiments, each retention schedule 122 may be linked to multiple jurisdiction triggers 128. Thus, when a retention schedule 122 is assigned to a record 110 having multiple jurisdiction codes (e.g., codes 119A, 119B, 119C), multiple expiration dates may be calculated for the record 110 using the jurisdiction triggers 128 that match each of the record's jurisdiction codes 119A-C. Any conflicts between the calculated expiration dates may be resolved by the specification generator 116 by applying conflict resolution rules. For instance, in cases in which the jurisdiction triggers 128 produce different expiration dates, the conflict resolution rules may dictate that the most severe date (i.e., the date that is the furthest out in time) calculated for any trigger 128 should be selected as the record expiration date to be applied to the record 110. By linking multiple jurisdiction triggers 128 to a retention schedule 122 based on jurisdiction information 119, only a single retention schedule 122 need be assigned to a particular record 110 even though the record 110 may be subject to the different requirements of multiple jurisdictions.

In some embodiments, jurisdiction information 119 may not have been created for all or a portion of the records 110 maintained by the organization. In such situations, a default jurisdiction trigger 130 that is linked to the assigned retention schedule 122 may be applied.

In some embodiments, records may also be aggregated into a single group or container in accordance with aggregation rules. For instance, an aggregation rule may dictate that all financial records from the accounting department of a particular division within the organization should be grouped together. In such a case, the storage specification generator 116 may examine the retention schedules 122 assigned to each individual record 110 in the group, identify the longest record expiration date of all of the schedules 122, and then designate that date as a container expiration date. Thus, on the container expiration date, all of the records 110 that are aggregated in the container will be subject to the same action, e.g., transfer to archival storage, destruction, etc.

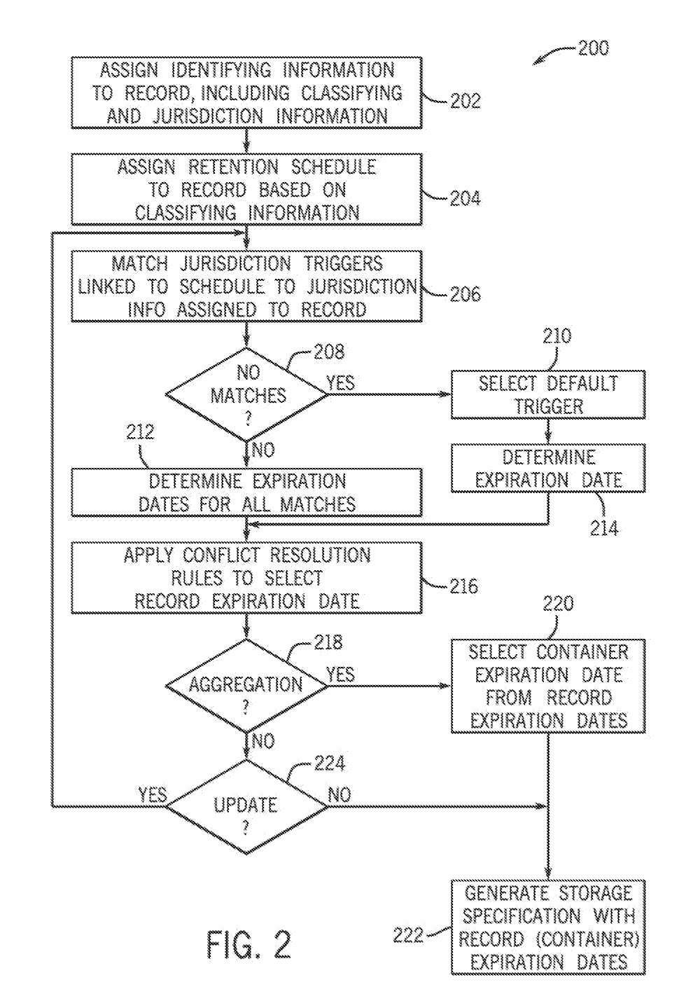

Turning now to FIG. 2, a flow chart of an exemplary technique 200 for multi-jurisdiction retention scheduling is shown. At block 202, upon origination of a record 110, identifying information 118 relating to the record 110 is created and assigned to the record 110. The identifying information 118 may include classifying information 117 and jurisdiction information 119. A jurisdiction-based retention schedule 122 may then be assigned to the record 110 based on the classifying information 117 (block 204). In some embodiments, if the assigned schedule 122 prescribes that the record 110 should be retained permanently, the record 110 may be marked with a “do not destroy” flag. In such as case, jurisdiction triggers 128 may not be assigned at this time. Otherwise, if there is no indication that the record 110 should be permanently retained, the jurisdiction triggers 128 linked to the schedule 122 may then be matched to jurisdiction information 119 associated with the record 110 (block 206). If jurisdiction information 119 has not been assigned to the record 110 (diamond 208), then a default jurisdiction trigger 130 may be selected (block 210). The expiration dates for the record 110 may then be calculated for each jurisdiction trigger 128 (block 212) or default trigger 130 (block 214). If multiple expiration dates result, then conflict resolution rules may be applied to select a record expiration date from the various calculated expiration dates (block 216). In some embodiments, the conflict rules may dictate that the retention of the record be governed by the most severe expiration date calculated for any of the jurisdiction triggers 128.

If desired, an aggregation rule may be applied to aggregate a particular class of records 110 into a container (diamond 218). If aggregation is applied, then a container expiration date also is calculated (block 220). The record expiration dates and the container expiration date may then be added to the storage specification 112 that is stored with or linked to the record 110 in the document repository 114 so that appropriate action can be taken with respect to the record 110 upon occurrence of the record/container expiration dates (block 222). Such actions may include, for instance, transferring the record 110 to archival storage, destroying the record, sending a notification to a records manager, etc.

In some embodiments, the jurisdiction triggers 128 or default triggers 130 may be associated with future trigger events, such as an employee termination date, end-of-year date, etc. In such cases, expiration dates cannot be calculated at the time that the schedule 122 is assigned and the storage specification 112 is created for the record 110. Accordingly, in an exemplary embodiment, if the base event for the trigger 128 or 130 is a future event, then the record 110 may be marked with a flag or other notifier that indicates that the record 110 should not be destroyed until a record expiration date can be determined. When the future date occurs or when the record 110 is updated to reflect the occurrence of the future event, then an update of the record expiration date is required (diamond 224). The expiration dates for triggers 128/130 linked to the date or event may then be calculated and the storage specification 112 automatically updated accordingly. The “do not destroy” flag (or other notifier) also may be removed.

A “do not destroy” flag also may be set due to a retention hold that has been placed on certain types or classes of records (e.g., for the purpose of preserving electronic evidence). In such a case, the calculation of expiration dates may be suspended until the flag is removed. Once the retention hold is lifted, the “do not destroy” flag may be removed and the record expiration dates may then be automatically determined and/or updated, as needed.

Updates to the storage specification 112 may also be automatically triggered in response to modification of jurisdiction information 119 (diamond 224). For instance, if a user assigns additional jurisdiction information 119 or otherwise changes the jurisdiction information 119 associated with a record 110, then re-calculation of the record expiration date and updating of the storage specification 112 will be automatically triggered. As another example, if the retention period or base trigger event associated with a jurisdiction trigger 128 is modified, then any retention schedule 122 that is linked to the modified jurisdiction trigger 128 may automatically recalculate its expiration date. Any conflicts between any remaining active jurisdiction triggers 128 linked to the record's retention schedule 122 may be resolved as discussed above.

It should be understood that the steps of the technique 200 illustrated in FIG. 2 are provided as examples only and that different, additional, or fewer steps may be performed. Moreover, the order of the steps is not necessarily limited to the order shown in FIG. 2, and other step orders are contemplated as may fall within the scope of embodiments of the invention.

Any of the techniques (including technique 200 of FIG. 2) described above may be implemented in software, hardware, or a combination thereof. Instructions of software are loaded for execution on a processor (such as processing device 106 in FIG. 1). A processor can include a microprocessor, microcontroller, processor module or subsystem, programmable integrated circuit, programmable gate array, or another control or computing device. As used here, a “processor” can refer to a single component or to plural components (e.g., one CPU or multiple CPUs or one computer or multiple computers).

Data and instructions of software are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions of the software discussed above can be provided on one computer-readable or computer-usable storage medium, or alternatively, can be provided on multiple computer-readable or computer-usable storage media distributed in a large system having possibly plural nodes. “Storage media” is intended to either a singular storage medium or plural storage media. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, implementations may be practiced without some or all of these details. Other implementations may include modifications and variations from the details discussed above. It is intended that the appended claims cover such modifications and variations.

What is claimed is:

1. A method for managing retention of records for multiple jurisdictions, comprising:
assigning, using a processor-based device, a retention schedule to a record based on classification information associated with the record, wherein the retention schedule is linked to a plurality of jurisdiction triggers;
determining expiration dates for the jurisdiction triggers linked to the retention schedule that correspond to jurisdiction information associated with the record; and
selecting a determined expiration date as a record expiration date.

2. The method as recited in claim 1, wherein the jurisdiction triggers linked to the retention schedule include a default jurisdiction trigger, and wherein the method further comprises determining a default expiration date for the default jurisdiction trigger, and wherein selecting a determined expiration date comprises selecting the default expiration date as the record expiration date if none of the jurisdictional triggers corresponds to jurisdictional information associated with the record.

3. The method as recited in claim 1, wherein selecting one of the expiration dates comprises selecting the expiration date that expires at a latest time.

4. The method as recited in claim 1, further comprising:
generating a storage specification that includes the record expiration date; and
storing the storage specification and the corresponding record in a record repository.

5. The method as recited in claim 1, further comprising automatically updating the record expiration date in response to modification of a jurisdiction trigger linked to the retention schedule assigned to the record.

6. The method as recited in claim 1, further comprising automatically updating the record expiration date in response to modification of the jurisdiction information assigned to the record.

7. The method as recited in claim 1, further comprising assigning the classifying information to the record upon creation of the record, wherein the classifying information includes at least one of a business context and a record type.

8. The method as recited in claim 1, further comprising:
aggregating records in a group; and
selecting a group expiration date from the record expiration dates corresponding to the records in the group.

9. The method as recited in claim 1, wherein the jurisdiction triggers define retention periods and base trigger events for determining expiration dates.

10. The method as recited in claim 9, wherein each jurisdiction trigger includes a jurisdiction code, and wherein determining expiration dates comprises:
comparing the jurisdiction code for each jurisdiction trigger to jurisdiction information associated with the record; and
determining an expiration date for a jurisdiction trigger only if the jurisdiction code matches the jurisdiction information associated with the record.

11. An article comprising at least one machine-readable storage medium storing instructions that upon execution cause a computer system to:
determine a class of a record to be stored in a record repository managed by the computer system;
select a retention schedule for a record based on the determined class, wherein the retention schedule is linked to a plurality of jurisdiction triggers;
identify the jurisdiction triggers linked to the selected retention schedule that correspond to jurisdiction codes associated with the record; and
determine a record expiration date for the record using the identified jurisdiction triggers.

12. The article as recited in claim 11, wherein the instructions upon execution further cause the computer system to:
select a default jurisdiction trigger if none of the jurisdiction triggers correspond to jurisdiction codes associated with the record; and
determine a record expiration date for the record using the default jurisdiction trigger.

14. The article as recited in claim 12, wherein the default jurisdiction trigger is selected based on the class of the record.

15. The article as recited in claim 11, wherein the instructions upon execution further cause the computer system to:
generate a storage specification including the record expiration date; and
store the record and the storage specification in a record repository.

16. The article as recited in claim 11, wherein the instructions upon execution further cause the computer system to update the record expiration date for a particular record responsive to a modification of a jurisdiction trigger linked to the retention schedule assigned to the particular record.

17. The article as recited in claim 11, wherein the instructions upon execution further cause the computer system to update the record expiration date for a particular record responsive to a modification of a jurisdiction code associated with the particular record.

18. The article as recited in claim 11, wherein the record expiration date is determined by calculating expiration dates for the identified jurisdiction triggers and selecting the longest expiration date of the calculated expiration dates as the record expiration date.

19. The article as recited in claim 11, wherein the instructions upon execution further cause the computer system to:
aggregate records into a group; and
determine a group expiration date from the record expiration dates for the records in the group.

20. A computer system, comprising:
at least one processor;
a storage specification generator executable on the at least one processor to:
assign a multi-jurisdiction retention schedule to a record based on a class of the record, wherein the multi-jurisdiction retention schedule is linked to a plurality of jurisdiction triggers;
identify the jurisdiction triggers linked to the assigned retention schedule that correspond to jurisdiction information associated with the record;
determine a record expiration date for the record using the identified jurisdiction triggers; and
generate a storage specification associated with the record, the storage specification including the record expiration date.
